(19) United States
(12) Patent Application Publication
(10) Pub. No.: US 2026/0030746 A1
(43) Pub. Date: Jan. 29, 2026

(54) Optical Determination of pH Level of Biological Samples

(71) Applicant: University of Washington, Seattle, WA (US)

(72) Inventors: Eric J. Seibel, Seattle, WA (US); Manuja Sharma, Seattle, WA (US); Yang Jiang, Seattle, WA (US); Leonard Y. Nelson, Seattle, WA (US); Shwetak N. Patel, Seattle, WA (US)

(21) Appl. No.: 18/993,379

(22) PCT Filed: Jul. 13, 2023
(86) PCT No.: PCT/US2023/027616

§ 371 Date: Jan. 10, 2025

Related U.S. Application Data
(60) Provisional application No. 63/368,532, filed on Jul. 15, 2022.

(51) Int. Cl. G06T 7/00

(52) U.S. Cl. CPC G06T 7/0012; G06T 2207/10064; G06T 2207/20024; G06T 2207/20081; G06T 2207/30036

(57) ABSTRACT

A method includes accessing training images and labels, where the training images depict fluorescence from samples and the labels indicate pH levels of the samples. The method also includes training a computational model, using the training images and the labels, to determine pH levels on tissue inside of a patient's mouth depicted by captured images. Another method includes generating one or more images of tissue inside of a patient's mouth, where the one or more images depict fluorescence from the tissue. The method also includes determining a pH level on the tissue using a model and pixel intensities of the one or more images, and generating an indication of the pH level on the tissue.

### CROSS-REFERENCE TO RELATED APPLICATIONS

This application claims priority to U.S. Provisional Patent Application No. 63/368,532, filed on Jul. 15, 2022, the entire contents of which are incorporated by reference herein.

### STATEMENT REGARDING FEDERALLY SPONSORED RESEARCH OR DEVELOPMENT

This invention was made with government support under Grant No. 1631146 awarded by the National Science Foundation. The government has certain rights in the invention.

### BACKGROUND

Tooth decay affects billions of people around the world and can cause excruciating pain and tooth loss. Addressing tooth decay after it has occurred can be expensive. Visual and tactile inspection is used to evaluate dental surfaces to identify tooth decay. Current diagnostic tools are used to detect tooth decay, but are generally not used to identify areas most at risk of decay in the future.

### SUMMARY

A first example is a method comprising: accessing training images and labels, wherein the training images depict fluorescence from samples and the labels indicate pH levels of the samples; and training a computational model, using the training images and the labels, to determine pH levels on tissue inside of a patient's mouth depicted by captured images.

A second example is a non-transitory computer readable medium storing instructions that, when executed by one or more processors of a computing device, cause the computing device to perform the method of the first example.

A third example is a computing device comprising: one or more processors; and a computer readable medium storing instructions that, when executed by the one or more processors, cause the computing device to perform the method of the first example.

A fourth example is a method comprising: generating one or more images of tissue inside of a patient's mouth, wherein the one or more images depict fluorescence from the tissue; determining a pH level on the tissue using a model and pixel intensities of the one or more images; and generating an indication of the pH level on the tissue.

A fifth example is a non-transitory computer readable medium storing instructions that, when executed by an imaging device, cause the imaging device to perform the method of the fourth example.

A sixth example is an imaging device comprising: one or more image sensors; one or more light sources; a user interface and/or a communication interface; one or more processors; and a computer readable medium storing instructions that, when executed by the one or more processors, cause the imaging device to perform the method of the fourth example.

A seventh example is an imaging device comprising: a source of blue light configured to illuminate a sample; a source of white light configured to illuminate the sample; a long pass filter having a cutoff wavelength of 435 nm +/−15 nm; a beam splitter configured to receive light filtered by the long pass filter; a first band pass filter having a critical wavelength of 520 nm +/−15 nm configured to receive a first beam from the beam splitter; a second band pass filter having a critical wavelength of 550 nm +/−15 nm configured to receive a second beam from the beam splitter; a first complementary metal oxide semiconductor (CMOS) image sensor configured to generate a first image of the first beam; and a second CMOS image sensor configured to generate a second image of the second beam.

An eighth example is an imaging device comprising: a source of blue light configured to illuminate a sample; a long pass filter having a cutoff wavelength of 435 nm +/−5 nm; a first beam splitter configured to split light filtered by the long pass filter into a first beam having wavelengths less than 470 nm +/−5 nm and an axis beam having wavelengths greater than 470 nm +/−5 nm; a first CMOS image sensor configured to generate a first image of the first beam; a second beam splitter configured to split the axis beam into a second beam having wavelengths less than 535 nm +/−5 nm and a third beam having wavelengths greater than 535 nm +/−5 nm; a first band pass filter having a first critical wavelength of 520 nm +/−5 nm configured to receive the second beam from the second beam splitter; a second band pass filter having a second critical wavelength of 550 nm +/−5 nm configured to receive the third beam from the second beam splitter; a second CMOS image sensor configured to generate a second image of the second beam after processing by the first band pass filter; and a third CMOS image sensor configured to generate a third image of the third beam after processing by the second band pass filter.

A ninth example is an imaging device comprising: a source of blue light configured to illuminate a sample; a long pass filter having a cutoff wavelength of 435 nm +/−5 nm; a CMOS image sensor; a first band pass filter having a critical wavelength of 520 nm +/−5 nm; a second band pass filter having a critical wavelength of 550 nm +/−5 nm; a neutral density filter; and a filter apparatus operable to selectively place the first band pass filter, the second band pass filter, or the neutral density filter between the CMOS image sensor and the long pass filter.

The following documents are incorporated by reference herein: Chuqin Huang, Manuja Sharma, Lauren K. Lee, Matthew D. Carson, Mark E. Fauver, Eric J. Seibel, “Optical imaging of dental plaque pH,” Proc. SPIE 11315, Medical Imaging 2020: Image-Guided Procedures, Robotic Interventions, and Modeling, 113152Z (16 Mar. 2020); https://doi.org/10.1117/12.2551322. Sharma M, Lee L K, Carson M D, Park D S, An S W, Bovenkamp M G, Cayetano J J, Berude I A, Xu Z, Sadr A, Patel S N, Seibel E J. O-pH: Optical pH Monitor to Measure Oral Biofilm Acidity and Assist in Enamel Health Monitoring. IEEE Trans Biomed Eng. 2022 Feb. 23;PP. doi: 10.1109/TBME.2022.3153659. Epub ahead of print. PMID: 35196222. Manuja Sharma, Jasmine Y. Graham, Philip A. Walczak, Ryan Nguyen, Lauren K. Lee, Matthew D. Carson, Leonard Y. Nelson, Shwetak N. Patel, Zheng Xu, Eric J. Seibel, “Optical pH measurement system using a single fluorescent dye for assessing susceptibility to dental caries (Erratum),” J. Biomed. Opt. 26(1) 019801 (13 Jan. 2021) https://doi.org/10.1117/1.JBO.26.1.019801. M. Sharma, M. D. Carson, J. Y. Graham, L. Y. Nelson, S. Patel and J. Eric Seibel, “Dental pH Opti-Wand (DpOW): measuring oral acidity to guide enamel preservation,” 2018 40th Annual International Conference of the IEEE Engineering in Medicine and Biology Society (EMBC), Honolulu, HI, USA, 2018, pp. 3738-3741, doi: 10.1109/EMBC.2018.8513280. Murari K, Etienne-Cummings R, Thakor N, Cauwenberghs G. A CMOS In-Pixel CTIA High Sensitivity Fluorescence Imager. IEEE Trans Biomed Circuits Syst. 2011 Oct;5(5):449-458 doi: 10.1109/tbcas.2011.2114660 Epub 2011 Mar. 24. PMID: 23136624: PMCID: PMC3488880. Balsam J, Bruck H A, Kostov Y, Rasooly A. Image stacking approach to increase sensitivity of fluorescence detection using a low cost complementary metal-oxide-semiconductor (CMOS) webcam. Sens Actuators B Chem. 2012:171-172:141-147. doi: 10.1016/j.snb.2012.02.003. PMID: 23990697: PMCID: PMC3752898.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of a computing device, according to an example.

FIG. 2 is a block diagram of an imaging device, according to an example.

FIG. 3 is a schematic diagram of an imaging device, according to an example.

FIG. 4 is a schematic diagram of an imaging device, according to an example.

FIG. 5 is a schematic diagram of an imaging device, according to an example.

FIG. 6 is a block diagram of a method, according to an example.

FIG. 7 is a block diagram of a method, according to an example.

### DETAILED DESCRIPTION

Methods of the disclosure are related to providing training images and labels for training a computational model. The training images depict fluorescence from samples (e.g., from fluorescein dye on the samples) and the labels (e.g., metadata) indicate known pH levels of the samples and/or a known fluorescein concentration or dose corresponding to the samples. The training images can be produced from images captured using complementary metal-oxide semiconductor (CMOS) image sensors, for example. The training images can be captured as “still frame” images or as a video stream of frames captured in rapid succession.

The samples can include cuvettes, extracted teeth, false teeth, gums, or other surfaces that are similar to the tooth surfaces within a living patient's mouth. Other samples can include in vivo tooth and gum surfaces.

Many surfaces within the human mouth have bacteria (i.e., biofilm) covering them. Thickness and maturity of the biofilm depends on the amount of protection from mechanical disturbance. Note, similar to caries, gum disease (gingivitis) comes from bacterial infection.

Prior to capturing or generating each training image, the sample in each training image is immersed or sprayed with an optically clear buffer solution having a known pH (potential of hydrogen) with fluorescein dye concentration level (e.g., in the case of ex vivo samples), or is subjected to a fluorescein dye at known concentration (e.g., in the case of in vivo tooth surfaces) when there is a calibrated optical instrument to measure in vivo pH. Thus, one or more labels are generated for each training image that indicates the pH level of the corresponding sample, that is, the pH level induced by application of the buffered pH and dye solution mixture to that sample, or just the dye solution when there is a calibrated instrument to verify the pH levels being measured from that sample. Depending on how the sample is prepared, the label can identify a pH level for the entire sample using a small pH electrode, or the pH level can be determined empirically on a more localized basis with scanning fiber endoscopy (SFE), with the labels indicating different pH levels at different locations on the sample.

The training images are generally provided as follows. First, training images are generated for ex vivo samples such as cuvettes, extracted teeth, and/or false teeth. As an initial step, control images are captured for each sample prior to application of a pH buffer. Next, a pH buffer solution having a known pH level is applied to the ex vivo samples and labels are assigned to each image depicting each respective ex vivo sample. A known concentration of fluorescein is then applied to the ex vivo samples. First training images can be generated by capturing images of the ex vivo samples after treatment with the buffer solution and fluorescein, and subtracting the control images to remove the reflectance background. This isolates the fluorescence signal from the fluorescein, which includes information about the pH level of the sample. The computational model is first trained using the labels and training images depicting the ex vivo samples.

Next, training images are generated for in vivo tooth surfaces that is, tooth surfaces of a living patient. As an initial step, control images are captured (e.g., using SFE) for each in vivo sample prior to application of fluorescein. For example, SFE is used to image the three-dimensional tooth surfaces as two-dimensional images or as three-dimensional images in a stereo, a confocal, a-LIDAR-enhanced, or a post-processed format (e.g., using motion algorithms). Thus, the control images include some auto-fluorescence (e.g., induced by blue light) that is naturally present in the in vivo tooth surfaces as well as reflectance (e.g., induced by white light) from the ambient lighting conditions and any applied light. Next, fluorescein is applied to the in vivo tooth surfaces. After calibration and training using the images of the static condition of resting pH from in vivo oral biofilms covering teeth, the various spatial locations of different pH values can be used to calibrate and train the optical pH measurement when there is a known high-quality in vivo measurement technique, such as SFE. For example, in areas of thicker, more mature and less accessible oral biofilms the resting pH will be typically lower than thinner and less mature biofilms that are more exposed to the saliva at near neutral pH. Thicker biofilms covering enamel also typically hold more fluorescein so the fluorescence signals are stronger, resulting in a more precise pH measurement at the regions of higher risk for acid generation that demineralizes the enamel surface.

In some examples, images of the in vivo tooth surfaces can be captured at various times during a sugar rinse such that the images correspond to varying levels of pH. The control images of each sample can be subtracted from the images captured of that sample during various stages of the sugar rinse to obtain more highly calibrated second training images that isolate the fluorescence of the fluorescein, which includes information about the pH of the in vivo tooth surfaces.

In some examples, images of the in vivo and ex vivo samples are pre-filtered to examine selected wavelength ranges of the images. For example, blue light can be used to illuminate the samples, and any light fluoresced or reflected from the samples can be long pass filtered (e.g., λ=435 nm) then split by a beam splitter. The first beam can be band pass filtered at a first wavelength (e.g., centered at λ=520 nm) and the second beam can be band pass filtered at a second wavelength (e.g., centered at λ=550 nm). Images generated from the first beam and the second beam can be labeled with known pH levels so that these image pairs corresponding respectively to the first beam and the second beam can be used to train the computational model to use such image pairs captured during runtime to determine pH levels of unknown samples.

The computational model (e.g., any deep neural network (DNN) or neural network) uses the training images of the ex vivo samples and/or in vivo tooth surfaces and corresponding labels to develop a model that maps fluorescent pixel intensities of the training images to pH levels on a pixel-by-pixel basis or on a basis of larger groups of pixels. The model can then be used to determine unknown pH levels of images of a patient's mouth, for example, to identify conditions within the patient's mouth that are conducive for tooth decay.

In various runtime examples, the inside of a patient's mouth is illuminated with blue light (e.g., 380 nm-500 nm), white light, or only ambient light that is similar to that which is typical during a dental examination (e.g., bright dental lamps). The lighting devices that generate the white light and the blue light are generally light emitting diodes (LEDs). The ambient light is generally present during exposure to the white light and blue light as well. Blue light can be used to emphasize fluorescence of fluorescein within the return signal that is captured, white light can be used to produce an image over which the blue light return signal can be overlaid. Ambient light can be used to determine background conditions that can be used as a reference for comparison to better isolate fluorescence of fluorescein. A trained computational model (e.g., a DNN or another machine learning platform) or an analytical model (e.g., one or more equations) is used to evaluate the one or more images and determine pH levels at various locations within the patient's mouth. A display screen can display brightness or varying color as a proxy for varying levels of pH on a pixel by pixel basis within the patient's mouth. For example, all images can be captured via monochrome or RGB CMOS image sensors. The runtime images can be captured as “still frame” images or as a video stream of frames captured in rapid succession.

Within the patient's mouth, a sugar rinse can create a dynamically changing pH value due to bacterial metabolism creating acid (e.g., rapidly dropping pH) and then after sugar is metabolized the saliva typically rebalances the pH back up more slowly with simple diffusion into the oral biofilm covering the teeth. Thus, application of a sugar rinse can help enhance contrast in captured images between (1) “active” caries or tooth decay areas and (2) more normal areas of the teeth, because of the variation in fluorescein fluorescence caused by the varying pH between the decayed and normal areas. For calibrating and training the deep learning model, static values of pH are generally needed which are measured without adding sugar, so at the training stage only the fluorescein dye is added generally. This is called resting or fasting oral biofilm pH which is relatively static over time while it can vary spatially depending on location of biofilms covering the teeth. Once trained, the model can be used at runtime (with unknown pH levels) to measure dynamic pH when sugar is added with the fluorescein to detect “active” caries or tooth decay, versus arrested caries (covered by a layer of remineralized enamel).

Once the model is trained, sugar and fluorescein dye are used to measure the dynamic values of pH over time which can inform a dentist which areas are active caries compared to arrested caries which would not drop at all in pH or at least not as rapidly and greatly.

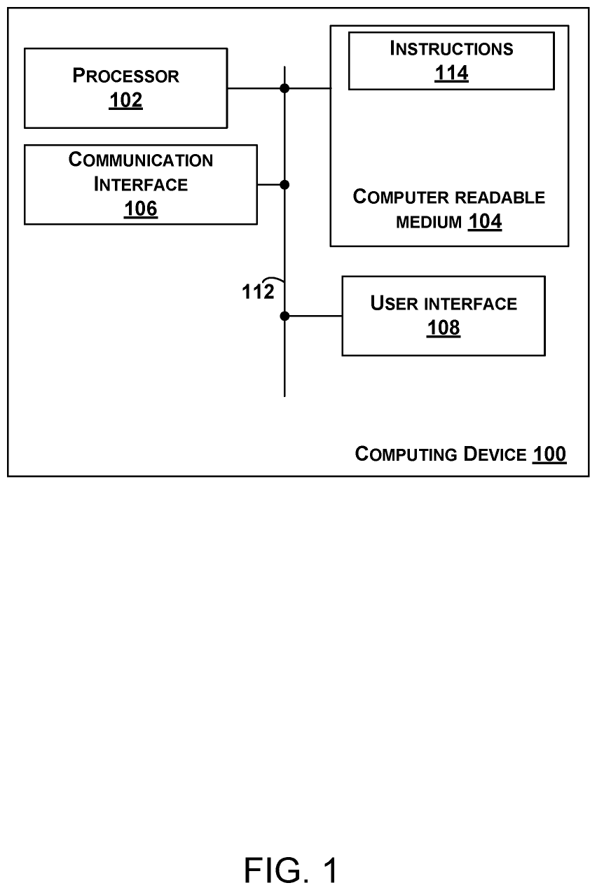

FIG. 1 is a block diagram of a computing device 100. The computing device 100 includes one or more processors 102, a non-transitory computer readable medium 104, a communication interface 106, and a user interface 108. Components of the computing device 100 are linked together by a system bus, network, or other connection mechanism 112.

The one or more processors 102 can be any type of processor(s), such as a microprocessor, a field programmable gate array, a digital signal processor, a multicore processor, etc., coupled to the non-transitory computer readable medium 104.

The non-transitory computer readable medium 104 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 104 can store instructions 114. The instructions 114 are executable by the one or more processors 102 to cause the computing device 100 to perform any of the functions or methods described herein.

The communication interface 106 can include hardware to enable communication within the computing device 100 and/or between the computing device 100 and one or more other devices. The hardware can include any type of input and/or output interfaces, a universal serial bus (USB). PCI Express, transmitters, receivers, and antennas, for example. The communication interface 106 can be configured to facilitate communication with one or more other devices, in accordance with one or more wired or wireless communication protocols. For example, the communication interface 106 can be configured to facilitate wireless data communication for the computing device 100 according to one or more wireless communication standards, such as one or more Institute of Electrical and Electronics Engineers (IEEE) 801.11 standards, ZigBee standards, Bluetooth standards, etc. As another example, the communication interface 106 can be configured to facilitate wired data communication with one or more other devices. The communication interface 106 can also include analog-to-digital converters (ADCs) or digital-to-analog converters (DACs) that the computing device 100 can use to control various components of the computing device 100 or external devices.

The user interface 108 can include any type of display component configured to display data. As one example, the user interface 108 can include a touchscreen display. As another example, the user interface 108 can include a flat-panel display, such as a liquid-crystal display (LCD) or a light-emitting diode (LED) display. The user interface 108 can include one or more pieces of hardware used to provide data and control signals to the computing device 100. For instance, the user interface 108 can include a mouse or a pointing device, a keyboard or a keypad, a microphone, a touchpad, or a touchscreen, an audio speaker, among other possible types of user input or output devices. Generally, the user interface 108 can enable an operator to interact with a graphical user interface (GUI) provided by the computing device 100 (e.g., displayed by the user interface 108).

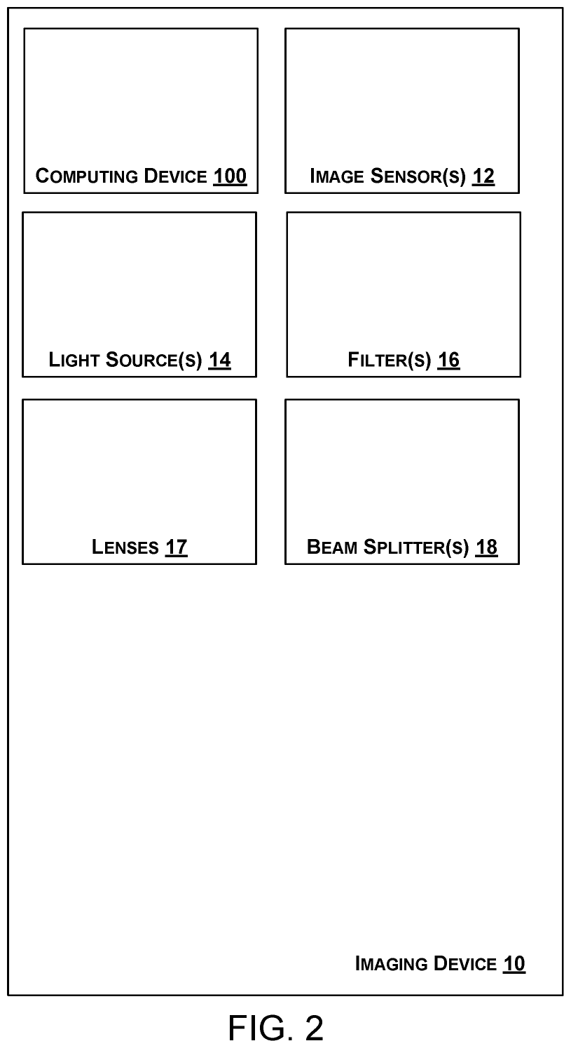

FIG. 2 is a block diagram of an imaging device 10. The imaging device 10 includes the computing device 100, one or more image sensors 12, one or more light sources 14, one or more filters 16, lenses 17, and one or more beam splitters 18.

The image sensor(s) 12 include any devices configured to generate signals representing a two-dimensional array of color values and/or intensity values based on detection of visible light over a two-dimensional area. Examples include charge coupled devices or CMOS sensors. The image sensor 12 can be monochrome or color in various examples.

The light source(s) 14 generally include light emitting diodes (LEDs) configured to emit various colors of light. For example, the light source(s) can include one or more LEDs configured to selectively emit any wavelength range of the visible spectrum.

The filter(s) 16 can include one or more pieces of optically clear material (e.g., glass or plastic) coated with one or more layers of material configured to generate constructive and/or destructive interference for light at desired wavelength ranges (e.g., a band pass or bandstop filter). Additionally, the filter(s) 16 can include material that is configured to have an abrupt change in transmissivity and/or reflectivity at a desired wavelength range (e.g., a long pass or short pass filter).

The beam splitter(s) 18 generally include one or more prisms configured to split an incoming beam of light into two outgoing beams that travel in different directions. In some examples, the beam splitter 18 is frequency dependent and sends incoming wavelengths that are less than a critical wavelength in a first direction (90-degree angle by reflecting off a 45-degree dichroic beamsplitter) and incoming wavelengths that are greater than the critical wavelength in a second direction, such as continuing along the original axis of light propagation through the dichroic beamsplitter.

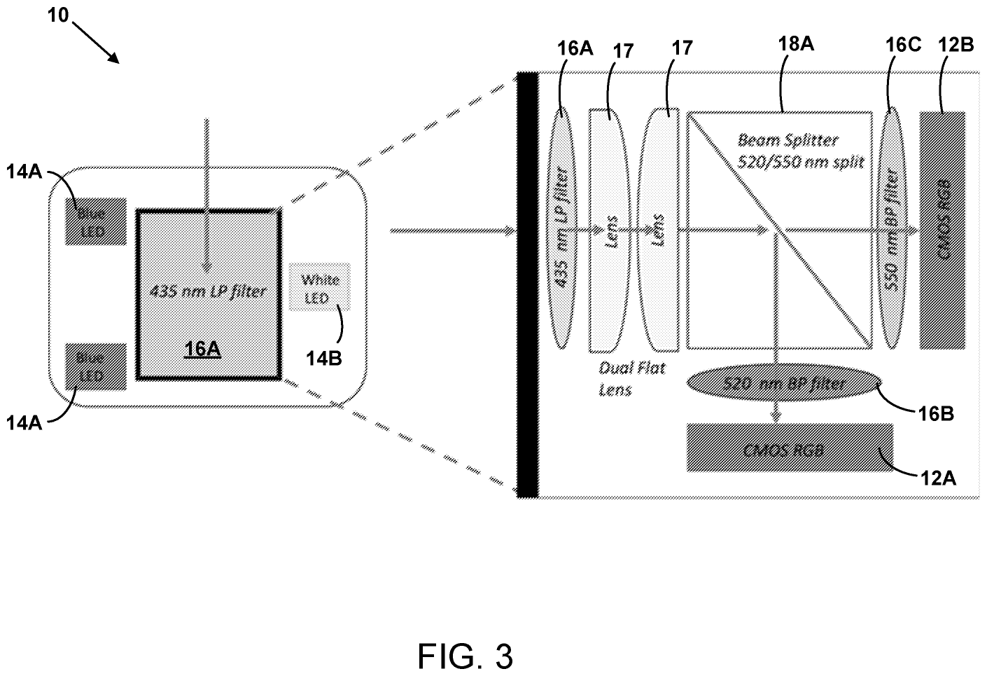

FIG. 3 is a schematic diagram of an example of the imaging device 10. In FIG. 3, the imaging device 10 includes two light sources 14A, a light source 14B, a long pass filter 16A, lenses 17, a beam splitter 18A, a band pass filter 16B, a band pass filter 16C, an image sensor 12A, and an image sensor 12B.

The light sources 14A are configured to illuminate a sample with blue light having wavelengths ranging from 380 nm to 500 nm and the light source 14B is configured to illuminate a sample with white light having wavelengths ranging from 380 nm to 700 nm.

In some examples, “blue light” as used anywhere in this disclosure has wavelengths ranging from 400 nm to 440 nm, or 415 nm to 425 nm. More specifically, the blue light can have a peak emission of 420 nm +/−5 nm with an emission band not wider than +/−20 nm for at least 95% of the power spectral density of the blue light.

In some examples, “white light” can have reduced power in the green spectrum so as not to photobleach the fluorescein dye.

The long pass filter 16A has a critical wavelength within a range of 430 nm to 450 nm and thus has a higher transmissivity for wavelengths greater than the critical wavelength (e.g., 435 nm) when compared to wavelengths less than the critical wavelength. Light that passes through the long pass filter 16A then passes through the lenses 17 and then impinges the beam splitter 18A.

The beam splitter 18A is configured to receive light filtered by the long pass filter 16A. The beam splitter 18A sends a first beam of the light toward the band pass filter 16B and a second beam of the light toward the band pass filter 16C. The first beam has mostly wavelengths that are less than 535 nm and the second beam has mostly wavelengths that are greater than 535 nm.

The band pass filter 16B has a passband wavelength within a range of 505 nm to 535 nm. Thus, the transmissivity of the band pass filter 16B is much higher for wavelengths close to the center of the passband (e.g., 520 nm) compared to wavelengths that are not close to the critical or cutoff wavelengths at the edges of the passband. Thus, the image sensor 12A (e.g., a CMOS RGB sensor) coupled with the band pass filter 16B primarily detects wavelengths of light from the sample that are within the passband of the band pass filter 16B centered at 520 nm.

The band pass filter 16C has a passband wavelength within a range of 535 nm to 565 nm. Thus, the transmissivity of the band pass filter 16C is much higher for wavelengths close to the center of the passband (e.g., 550 nm) compared to wavelengths that are not close to the critical or cutoff wavelengths at the edges of the passband. Thus, the image sensor 12B (e.g., a CMOS RGB sensor) coupled with the band pass filter 16C primarily detects wavelengths of light from the sample that are within the passband of the band pass filter 16C centered at 550 nm.

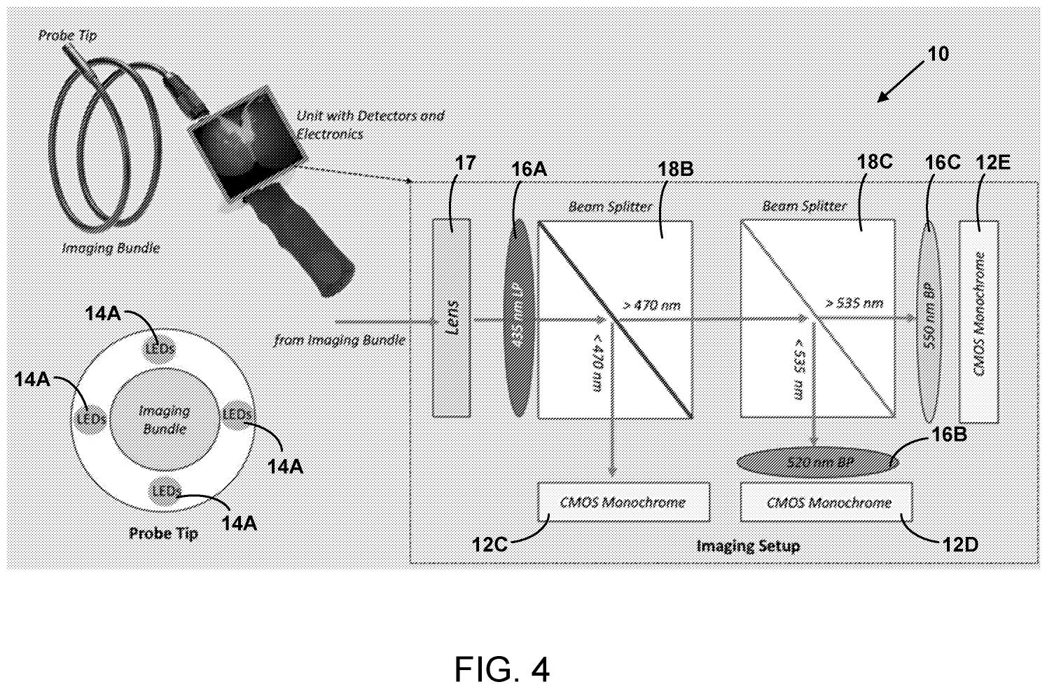

FIG. 4 is a schematic diagram of an example of the imaging device 10. In FIG. 4, the imaging device 10 includes the four light sources 14A, a lens 17, the long pass filter 16A, a beam splitter 18B, a beam splitter 18C, the band pass filter 16B, the band pass filter 16C, an image sensor 12C, an image sensor 12D, and an image sensor 12E.

Light is configured to pass through the lens 17 and impinge on the long pass filter 16A. The long pass filter 16A mostly allows wavelengths greater than the critical wavelength (e.g., 435 nm) of the long pass filter 16A to pass while mostly absorbing or reflecting wavelengths less than the critical wavelength of the long pass filter 16A. Thus, the beam splitter 18B generally receives wavelengths greater than the critical wavelength of the long pass filter 16A.

The beam splitter 18B is configured to receive light filtered by the long pass filter 16A. The beam splitter 18B sends a first beam of the light toward the image sensor 12C (e.g., a CMOS monochrome sensor) and a second beam of the light toward the beam splitter 18C. The first beam has mostly wavelengths that are less than 470 nm and the second beam has mostly wavelengths that are greater than 470 nm. Thus, the image sensor 12C detects light from the sample having wavelengths less than 470 nm which represents blue light that is reflected by the sample into the imaging device 10.

The beam splitter 18C receives, from the beam splitter 18B, light from the sample having wavelengths greater than 470 nm which includes fluorescence from the sample induced by the blue light incident on the sample from the light sources 14A. The beam splitter 18C sends a first beam of the light toward the image sensor 12D (e.g., a CMOS monochrome sensor) and a second beam of the light toward the image sensor 12E (e.g., a CMOS monochrome sensor). The first beam has mostly wavelengths that are less than 535 nm and the second beam has mostly wavelengths that are greater than 535 nm. Thus, the image sensor 12D detects light from the sample having wavelengths less than 535 nm and the image sensor 12E detects light from the sample having wavelengths greater than 535 nm, both of which includes fluorescence from the sample. The fluorescence from the sample is split based on wavelength between the image sensor 12D and the image sensor 12E because comparing the intensity of these two spectra of fluoresce is useful for determining pH of the sample.

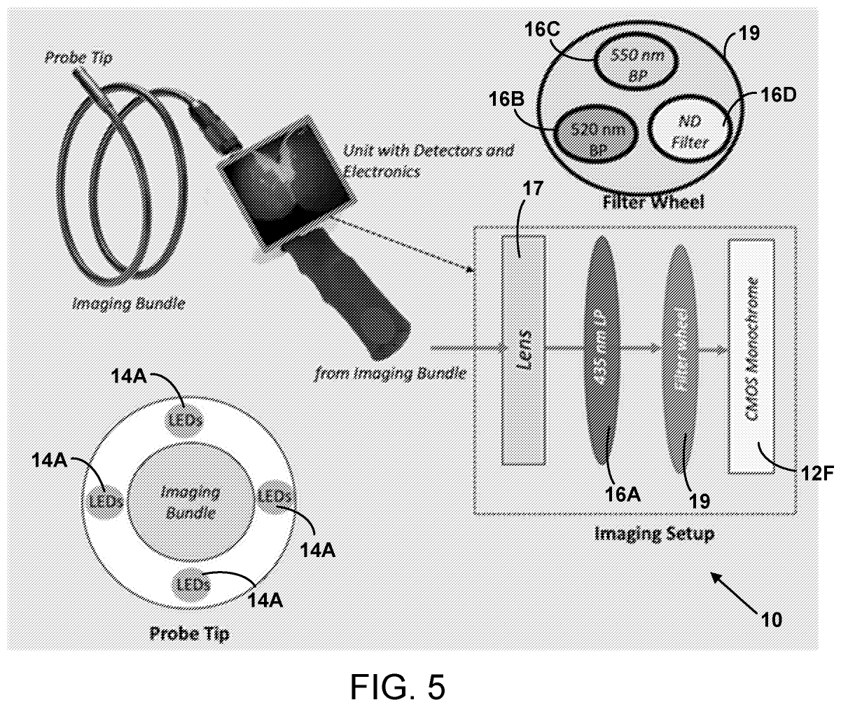

FIG. 5 is a schematic diagram of an example of the imaging device 10. The imaging device 10 includes four light sources 14A, a lens 17, the long pass filter 16A, the band pass filter 16B, the band pass filter 16C, a neutral density filter 16D, a filter apparatus 19 (e.g., a filter wheel), and an image sensor 12F.

The light sources 14A are configured to illuminate the sample with blue light as described above. Light reflected or fluoresced from the sample passes through the lens 17 and impinges the long pass filter 16A. The long pass filter 16A transmits mostly wavelengths of the light that are greater than 435 nm.

The filter apparatus 19 is configured to selectively place exactly one of the neutral density filter 16D, the band pass filter 16B, or the band pass filter 16C in front of the image sensor 12F (e.g., a CMOS monochrome sensor). Thus, depending on the position of the filter apparatus 19, the image sensor 12F detects wavelengths greater than 435 nm, wavelengths close to 520 nm, or wavelengths close to 550 nm. Comparing the intensity of these three samples of light is useful for determining pH of the sample.

If there is significant relative motion relative from the teeth and gums with respect to the camera video imaging system, the computing device in FIG. 1 can be used to register sequential images that are obtained from a time series of video frames using the filter wheel. This image processing method can be used to realign images to reduce error in determining the pH measurement, and also a similar registration method can be used to realign the resulting pH image with the white light image for a more accurate overlay of pH values.

The following discussion is related to one or more computing devices 100 using training images and corresponding labels to train a computational model. The computing device 100 trains the computational model so that the computational model can determine pH levels on tissue inside of a patient's mouth using images captured by the imaging device 10.

Accordingly, the computing device 100 accesses training images and labels. The training images depict fluorescence from samples and the labels indicate pH levels of the samples in the corresponding training images. The computing device 100 further trains a computational model, using the training images and the labels, to determine pH levels on tissue inside of a patient's mouth depicted by images captured by the imaging device 10 at run time. That is, the computing device 100 trains the computational model by identifying a relationship between fluorescence levels of fluorescein dye applied to the samples, a concentration of the fluorescein dye, and the pH levels of the tissue.

In some examples, the computational model is a deep neural network that is trained using training images that depict samples such as cuvettes, extracted teeth, false teeth, and/or in vivo tooth surfaces.

Generally, the computing device 100 trains the computational model using ex vivo samples such as cuvettes, extracted teeth, or false teeth and then uses transfer learning techniques to train the computational model using in vivo tooth surfaces.

As such, a technician applies buffer solutions to the ex vivo samples such that each of the ex vivo samples has a known pH level that is different from known pH levels of the other ex vivo samples. Typically, the buffer solutions include known concentrations of fluorescein dye (e.g., fluorescein sodium). Next, the imaging device 10 is used to generate the training images depicting fluorescence from the ex vivo samples. In some examples, this simply amounts to the imaging device 10 capturing the training images depicting fluorescence from the ex vivo samples without using further processing, but typically further processing is used.

For example, prior to the application of the buffer solutions to the ex vivo samples, the imaging device 10 captures control images of the ex vivo samples. The imaging device 10 then captures test images of the ex vivo samples after applying the buffer solutions. In this context, the training images depicting the ex vivo samples are generated by subtracting the control images from the test images. In this way, the training images emphasize the fluorescence of the samples induced by the fluorescein dye in the presence of varying pH levels. Accordingly, reflectance from the samples, which is not indicative of PH levels, is minimized.

Next, a technician uses the computing device 100 to generate labels for each training image of the ex vivo samples such that the labels indicate the pH level of each ex vivo sample and the concentration of fluorescein dye applied on each of the ex vivo samples. The computing device 100 then uses the training images of the ex vivo samples and the corresponding labels to train the computational model to determine pH levels on tissue inside of a patient's mouth depicted by images captured by the imaging device 10 at run time.

After training the computational model with images of ex vivo samples, the computing device 100 uses images of in vivo tooth surfaces to further train the computational model to determine pH levels on tissue inside of a patient's mouth depicted by images captured by the imaging device 10 at run time. Thus, the technician applies fluorescein dye and a sugar solution to the in vivo tooth surfaces. Next, the computing device 100 and/or the imaging device 10 generates training images depicting fluorescence from the in vivo tooth surfaces. Often, this involves capturing multiple images of each in vivo tooth surface sample over time (e.g., over 10 minutes, 20 minutes, or 30 minutes) because the pH level of the sample may drop over time as bacteria present on the samples generate higher levels of acid. This process provides a wide range of pH levels with which to train the computational model.

A calibrated scanning fiber endoscopy probe or a pH electrode is used to determine the pH level for each in vivo tooth surface sample and/or the pH level at various locations on each in vivo tooth surface sample. The technician uses the computing device 100 to generate one or more labels for each image of the in vivo tooth surface sample The labels typically indicate the pH level at one or more locations within each in vivo tooth surface sample and the concentration of fluorescein dye applied to each in vivo tooth surface sample.

In some examples, the imaging device 10 captures background images of the in vivo tooth surfaces while the patient's mouth is illuminated by ambient background light only. The ambient background light could be similar to room lighting typically present at a dentist's office, such as light generated by incandescent bulbs, white LED bulbs, florescent lighting etc. Next, the imaging device 10 captures blue light images while the patient's mouth is illuminated by blue light and the ambient background light. In this context, the computing device 10 generates the training images depicting fluorescence from the in vivo tooth surfaces by subtracting the background images from the blue light images. This further involves the computing device 100 registering the background images and the blue light images to a common coordinate system which precedes the computing device 100 generating the training images.

Some training examples relate to specific functionality and components of the imaging devices 10 shown in FIGS. 3-5. For example, the imaging device 10 illuminates the sample with blue light having wavelengths less than 500 nm (e.g., less than 460 nm) using one or more light sources 14A. Referring to FIG. 3, the image sensor 12A captures a first image of the sample while the sample is illuminated with the blue light. Thus, the first image represents light that is reflected from or fluoresced from the sample and subsequently filtered using the band pass filter 16B. Referring to FIG. 4, the image sensor 12D captures the first image of the sample while the sample is illuminated with the blue light. Thus, the first image represents light that is reflected from or fluoresced from the sample and subsequently filtered using the band pass filter 16B. Referring to FIG. 5, the image sensor 12F captures the first image of the sample while the sample is illuminated with the blue light. Accordingly, the first image represents light that is reflected from or fluoresced from the sample and subsequently filtered using the band pass filter 16B when the filter apparatus 19 is so positioned. The technician uses the computing device 100 to generate a label that indicates the known pH level of the sample depicted in the first image and/or a concentration of fluorescein dye applied on the sample.

Referring to FIG. 3, the image sensor 12B captures a second image of the sample while the sample is illuminated with the blue light. Thus, the second image represents light that is reflected from or fluoresced from the sample and subsequently filtered using the band pass filter 16C. Referring to FIG. 4, the image sensor 12E captures the second image of the sample while the sample is illuminated with the blue light. Thus, the second image represents light that is reflected from or fluoresced from the sample and subsequently filtered using the band pass filter 16C. Referring to FIG. 5, the image sensor 12F captures the second image of the sample while the sample is illuminated with the blue light. Accordingly, the second image represents light that is reflected from or fluoresced from the sample and subsequently filtered using the band pass filter 16C when the filter apparatus 19 is so positioned. The technician uses the computing device 100 to generate a label that indicates the known pH level of the sample depicted in the second image and/or a concentration of fluorescein dye applied on the sample.

The following discussion relates to systems and methods for determining pH of in vivo tooth surfaces by using images of the in vivo tooth surfaces captured at run time in conjunction with a machine learning model and/or a mathematical model.

Generally, the teeth and/or tissue inside the patient's mouth are pre-treated with fluorescein dye that fluoresces with an intensity that indicates a pH level and pre-treated with a sugar solution that causes areas of tooth decay to exhibit lower pH values than other areas of the teeth. Then, the imaging device 10 and/or the computing device 100 generate one or more input images of tissue inside of a patient's mouth such that the one or more input images depict fluorescence from the tissue. For example, a probe is inserted into the patient's mouth and moved around to capture the one or more input images of various areas of tissue inside the patient's mouth. The computing device 100 determines a pH level on the tissue using the model and pixel intensities of the one or more input images, and generates an indication of the pH level. For example, the computing device 100 displays the pH value via the user interface 108 or sends data indicating the pH level to another device using the communication interface 106.

In various examples, the imaging device 10 generates the one or more input images by capturing the one or more input images or alternatively by processing one or more images captured by the imaging device 10.

Referring to FIGS. 3-5, the imaging device 10 uses the light sources 14A to illuminate the inside of the patient's mouth with blue light having wavelengths less than 500 nm (e.g., less than 460 nm). Referring to FIG. 3, the image sensor 12A captures a first image while the inside of the patient's mouth is illuminated with the blue light. The first image represents first light that is reflected from or fluoresced from inside of the patient's mouth and subsequently filtered using the band pass filter 16B. Referring to FIG. 4, the image sensor 12D captures the first image while the inside of the patient's mouth is illuminated with the blue light. The first image represents first light that is reflected from or fluoresced from inside of the patient's mouth and subsequently filtered using the band pass filter 16B. Referring to FIG. 5, the image sensor 12F captures the first image while the inside of the patient's mouth is illuminated with the blue light. The first image represents first light that is reflected from or fluoresced from inside of the patient's mouth and subsequently filtered using the band pass filter 16B when the filter apparatus 19 is so positioned.

Referring to FIG. 3, the image sensor 12B captures a second image while the inside of the patient's mouth is illuminated with the blue light. The second image represents second light that is reflected from or fluoresced from inside of the patient's mouth and subsequently filtered using the band pass filter 16C. Referring to FIG. 4, the image sensor 12E captures the second image while the inside of the patient's mouth is illuminated with the blue light. The second image represents second light that is reflected from or fluoresced from inside of the patient's mouth and subsequently filtered using the band pass filter 16C. Referring to FIG. 5, the image sensor 12F captures the second image while the inside of the patient's mouth is illuminated with the blue light. The second image represents second light that is reflected from or fluoresced from inside of the patient's mouth and subsequently filtered using the band pass filter 16C when the filter apparatus 19 is so positioned.

In some examples, the computational machine learning model processes the first image corresponding to the band pass filter 16B and the second image corresponding to the band pass filter 16C, generates the one or more input images using the first image and the second image, and provides an output representing the pH level of the tissue. In other examples, the model used to determine the pH level is formulaic.

In some examples, the imaging device 10 captures background images of the inside of the patient's mouth while the inside of the patient's mouth is illuminated by ambient background light. Referring to FIG. 3, the image sensor 12A and the image sensor 12B each captures a background image of the inside of the patient's mouth while the inside of the patient's mouth is illuminated by ambient background light. To generate the input images, these background images are subtracted from the respective blue light images captured by the image sensor 12A and the image sensor 12B while the patient's mouth is illuminated with the blue light.

Referring to FIG. 4, the image sensor 12D and the image sensor 12E each captures a background image of the inside of the patient's mouth while the inside of the patient's mouth is illuminated by ambient background light. To generate the input images, these background images are subtracted from the respective blue light images captured by the image sensor 12D and the image sensor 12E while the patient's mouth is illuminated with the blue light.

Referring to FIG. 5, the image sensor 12F captures a first background image and a second background image of the inside of the patient's mouth while the inside of the patient's mouth is illuminated by ambient background light. The first background image is captured while the band pass filter 16B is positioned in front of the image sensor 12F and the second background image is captured while the band pass filter 16C is positioned in front of the image sensor 12F. To generate the input images, these background images are subtracted from the respective blue light images captured by the image sensor 12F while the patient's mouth is illuminated with the blue light.

In the examples of FIG. 3 and FIG. 4, the light passes through the long pass filter 16A before being captured.

The computing device 100 determines the pH level on the tissue by comparing (e.g., on a pixel-by-pixel basis) first pixel intensities of the first image corresponding to the band pass filter 16B to second pixel intensities of the second image corresponding to the band pass filter 16C. More specifically, the computing device 100 calculates a quotient of (a) a difference between one or more first intensities of one or more first pixels of the first image and one or more second intensities of one or more second pixels of the second image and (b) a sum of the one or more first intensities and the one or more second intensities. The computing device 100 multiplies the quotient by a first constant and then adds a second constant to obtain the pH level on the tissue. Regression techniques are used to select the first constant and the second constant.

For the purpose of conveying the pH level, the imaging device 10 captures a white light image while the inside of the patient's mouth is illuminated with white light. For example, the light passes through the neutral density filter 16D and is captured by the image sensor 12F. In this context, the pH level of the tissue can be conveyed by displaying an image that represents the varying florescence levels over the area of the tissue overlaid upon the white light image. The white light image can be further refined by subtracting the light within the white light image that corresponds to the ambient background lighting.

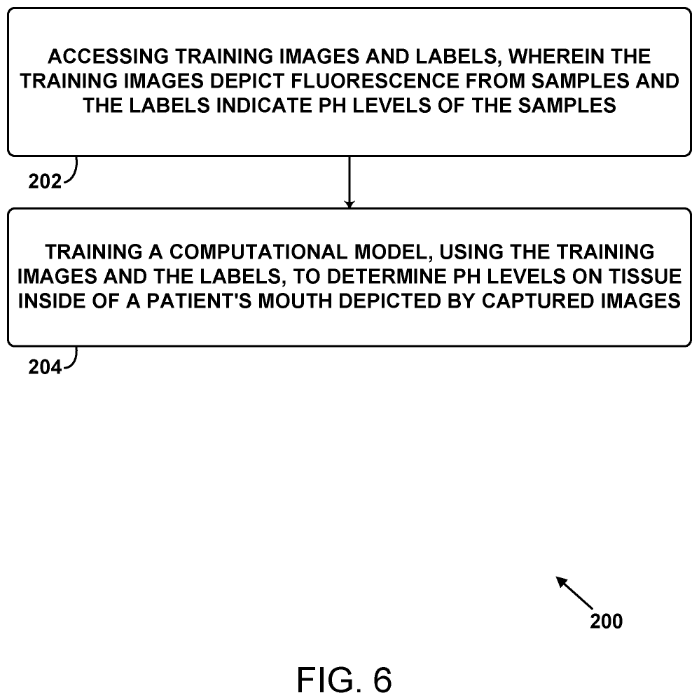

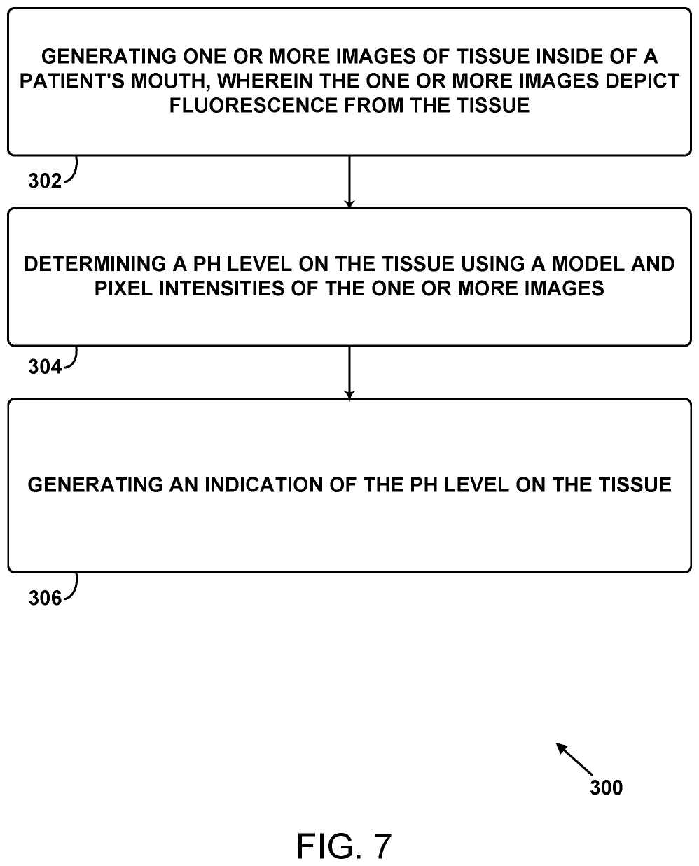

FIG. 6 and FIG. 7 are block diagrams of a method 200 and a method 300, which in some examples are performed by the computing device 100 and/or the imaging device 10. As shown in FIG. 6 and FIG. 7, the method 200 and the method 300 include one or more operations, functions, or actions as illustrated by blocks 202, 204, 302, 304, and 306. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes the computing device 100 accessing training images and labels, wherein the training images depict fluorescence from samples and the labels indicate pH levels of the samples. Functionality related to block 202 is discussed above with reference to FIGS. 3-5.

At block 204, the method 200 includes the computing device 100 training a computational model, using the training images and the labels, to determine pH levels on tissue inside of a patient's mouth depicted by captured images. Functionality related to block 204 is discussed above with reference to FIGS. 3-5.

At block 302, the method 300 includes the imaging device 10 generating one or more images of tissue inside of a patient's mouth, wherein the one or more images depict fluorescence from the tissue. Functionality related to block 302 is discussed above with reference to FIGS. 3-5.

At block 304, the method 300 includes determining a pH level on the tissue using a model and pixel intensities of the one or more images. Functionality related to block 304 is discussed above with reference to FIGS. 3-5.

At block 306, the method 300 includes generating an indication of the pH level on the tissue. Functionality related to block 306 is discussed above with reference to FIGS. 3-5.

### EXAMPLE EMBODIMENTS

Example 1 is a method comprising: accessing training images and labels, wherein the training images depict fluorescence from samples and the labels indicate pH levels of the samples; and training a computational model, using the training images and the labels, to determine pH levels on tissue inside of a patient's mouth depicted by captured images.

Example 2 is the method of example 1, wherein the samples comprise cuvettes, extracted teeth, false teeth, or in vivo tooth surfaces.

Example 3 is the method of any one of examples 1-2, wherein the samples comprise ex vivo samples, the method further comprising: applying buffer solutions to the ex vivo samples such that each of the ex vivo samples has a known pH level that is different from known pH levels of the other ex vivo samples, wherein the buffer solutions comprise fluorescein dye; and generating the training images depicting fluorescence from the ex vivo samples after applying the buffer solutions to the samples.

Example 4 is the method of example 3, further comprising: capturing control images of the ex vivo samples prior to applying the buffer solutions; and capturing test images of the ex vivo samples after applying the buffer solutions, wherein generating the training images depicting fluorescence from the ex vivo samples comprises subtracting the control images from the test images.

Example 5 is the method of any one of examples 3-4, further comprising generating the labels such that the labels indicate the known pH level for each of the ex vivo samples and a concentration of fluorescein dye applied on each of the ex vivo samples.

Example 6 is the method of any one of examples 1-5, wherein the samples comprise in vivo tooth surfaces, the method further comprising: applying fluorescein dye and a sugar solution to the in vivo tooth surfaces; and generating the training images depicting fluorescence from the in vivo tooth surfaces after applying the fluorescein dye and the sugar solution to the in vivo tooth surfaces.

Example 7 is the method of example 6, wherein generating the training images comprises capturing multiple images of an in vivo tooth surface over a duration of time.

Example 8 is the method of example 7, further comprising: determining pH levels of the in vivo tooth surface depicted by the multiple images using a calibrated pH detection tool; and generating the labels such that the labels indicate the pH levels of the in vivo tooth surface depicted by the multiple images.

Example 9 is the method of any one of examples 6-8, further comprising: capturing background images of the in vivo tooth surfaces while the patient's mouth is illuminated by ambient background light only; capturing blue light images while the patient's mouth is illuminated by blue light and the ambient background light; and generating the training images depicting fluorescence from the in vivo tooth surfaces by subtracting the background images from the blue light images.

Example 10 is the method of example 9, further comprising: registering the background images and the blue light images to a common coordinate system, wherein generating the training images comprises generating the training images after the registering.

Example 11 is the method of any one of examples 1-10, wherein the training images comprise first training images and second training images, the labels comprise first labels and second labels, the samples comprise ex vivo samples and in vivo tooth surfaces and accessing the training images and the labels comprises: accessing the first training images and the first labels, wherein the first training images depict the ex vivo samples and the first labels indicate first pH levels of the ex vivo samples; and accessing the second training images and the second labels, wherein the second training images depict the in vivo tooth surfaces and the second labels indicate second pH levels of the in vivo tooth surfaces, wherein training the computational model comprises training the computational model using the first training images, the first labels, the second training images, and the second labels.

Example 12 is the method of example 11 wherein training the computational model comprises training the computational model using the first training images and the first labels and thereafter training the computational model using the second training images and the second labels.

Example 13 is the method of any one of examples 1-12, wherein the samples include a fluorescein dye, and wherein training the computational model comprises training the computational model by identifying a relationship between fluorescence levels of the fluorescein dye, a concentration of the fluorescein dye, and the pH levels of the tissue.

Example 14 is the method of example 13, wherein the fluorescein dye comprises fluorescein sodium.

Example 15 is the method of any one of examples 1-14, wherein the computational model comprises a deep neural network.

Example 16 is the method of any one of examples 1-15, further comprising, for each of the samples: illuminating the sample with blue light having wavelengths less than 460 nm; capturing a first image of the sample while the sample is illuminated with the blue light, the first image representing first light that is reflected from or fluoresced from the sample and subsequently filtered using a first band pass filter having a first center wavelength; generating a first label of the labels that indicates the known pH level of the sample depicted in the first image and/or a concentration of fluorescein dye applied on the sample; capturing a second image of the sample while the sample is illuminated with the blue light, the second image representing second light that is reflected from or fluoresced from the sample and subsequently filtered using a second band pass filter having a second center wavelength that is different from the first center wavelength; and generating a second label of the labels that indicates the known pH level of the sample depicted in the second image and/or the concentration of fluorescein dye applied on the sample.

Example 17 is the method of example 16, wherein the first center wavelength is within a range of 508 nm to 532 nm.

Example 18 is the method of example 16 or example 17, wherein the second center wavelength is within a range of 535 nm to 565 nm.

Example 19 is a non-transitory computer readable medium storing instructions that, when executed by one or more processors of a computing device, cause the computing device to perform the method of any one of examples 1-18.

Example 20 is a computing device comprising: one or more processors; and a computer readable medium storing instructions that, when executed by the one or more processors, cause the computing device to perform the method of any one of examples 1-18.

Example 21 is a method comprising: generating one or more images of tissue inside of a patient's mouth, wherein the one or more images depict fluorescence from the tissue; determining a pH level on the tissue using a model and pixel intensities of the one or more images; and generating an indication of the pH level on the tissue.

Example 22 is the method of example 21, wherein generating the one or more images comprises capturing and/or processing the one or more images.

Example 23 is the method of example 21, wherein the one or more images comprise a first image and a second image, and wherein generating the one or more images comprises: illuminating the inside of the patient's mouth with blue light having wavelengths less than 460 nm; capturing the first image while the inside of the patient's mouth is illuminated with the blue light, the first image representing first light that is reflected from or fluoresced from inside of the patient's mouth and subsequently filtered using a first band pass filter having a first center wavelength; and capturing the second image while the inside of the patient's mouth is illuminated with the blue light, the second image representing second light that is reflected from or fluoresced from inside of the patient's mouth and subsequently filtered using a second band pass filter having a second center wavelength that is different from the first center wavelength, wherein determining the pH level on the tissue comprises comparing first pixel intensities of the first image to second pixel intensities of the second image.

Example 24 is the method of example 23, wherein the first center wavelength is within a range of 508 nm to 532 nm.

Example 25 is the method of example 23 or example 24, wherein the second center wavelength is within a range of 535 nm to 565 nm.

Example 26 is the method of any one of examples 23-25, wherein using the model comprises determining a quotient of (a) a difference between one or more first intensities of one or more first pixels of the first image and one or more second intensities of one or more second pixels of the second image and (b) a sum of the one or more first intensities and the one or more second intensities.

Example 27 is the method of example 26, wherein using the model further comprises multiplying the quotient by a first constant and then adding a second constant to obtain the pH level on the tissue.

Example 28 is the method of any one of examples 23-27, further comprising: capturing a background image of the inside of the patient's mouth while the inside of the patient's mouth is illuminated by ambient background light; and processing the first image and/or the second image by subtracting the background image from the first image and/or the second image prior to determining the pH level on the tissue.

Example 29 is the method of any one of examples 23-28, further comprising filtering the first light with a long pass filter having a critical wavelength that is less than the first center wavelength prior to filtering the first light with the first band pass filter.

Example 30 is the method of any one of examples 23-29, further comprising filtering the second light with a long pass filter having a critical wavelength that is less than the second center wavelength prior to filtering the second light with the second band pass filter.

Example 31 is the method of any one of examples 21-30, further comprising: capturing a third image while the inside of the patient's mouth is illuminated with white light, wherein generating the indication of the pH level comprises displaying a fourth image indicating the pH level on a pixel-by-pixel basis as an overlay over the third image.

Example 32 is the method of example 31, further comprising; capturing a background image while the inside of the patient's mouth is illuminated by ambient background light; and processing the third image by subtracting the background image from the third image prior to determining the pH level on the tissue.

Example 33 is the method of any one of examples 21-32, further comprising applying a solution comprising a sugar inside the patient's mouth, wherein generating the one or more images comprises generating the one or more images after applying the solution.

Example 34 is the method of any one of examples 21-33, wherein using the model comprises using the computational model of any one of examples 1-18.

Example 35 is the method of any one of examples 21-34, wherein generating the indication comprises generating the indication via a user interface.

Example 36 is the method of any one of examples 21-34, wherein generating the indication comprises transmitting the indication via a communication interface.

Example 37 is a non-transitory computer readable medium storing instructions that, when executed by an imaging device, cause the imaging device to perform the method of any one of examples 21-36.

Example 38 is an imaging device comprising: one or more image sensors; one or more light sources; a user interface and/or a communication interface; one or more processors; and a computer readable medium storing instructions that, when executed by the one or more processors, cause the imaging device to perform the method of any one of examples 21-36.

Example 39 is an imaging device comprising: a source of blue light configured to illuminate a sample; a source of white light configured to illuminate the sample; a long pass filter having a cutoff wavelength of 435 nm +/−15 nm; a beam splitter configured to receive light filtered by the long pass filter; a first band pass filter having a critical wavelength of 520 nm +/−15 nm configured to receive a first beam from the beam splitter; a second band pass filter having a critical wavelength of 550 nm +/−15 nm configured to receive a second beam from the beam splitter; a first CMOS image sensor configured to generate a first image of the first beam; and a second CMOS image sensor configured to generate a second image of the second beam.

Example 40 is an imaging device comprising: a source of blue light configured to illuminate a sample; a long pass filter having a cutoff wavelength of 435 nm +/−5 nm; a first beam splitter configured to split light filtered by the long pass filter into a first beam having wavelengths less than 470 nm +/−5 nm and an axis beam having wavelengths greater than 470 nm +/−5 nm; a first CMOS image sensor configured to generate a first image of the first beam; a second beam splitter configured to split the axis beam into a second beam having wavelengths less than 535 nm +/−5 nm and a third beam having wavelengths greater than 535 nm +/−5 nm; a first band pass filter having a first critical wavelength of 520 nm +/−5 nm configured to receive the second beam from the second beam splitter; a second band pass filter having a second critical wavelength of 550 nm +/−5 nm configured to receive the third beam from the second beam splitter; a second CMOS image sensor configured to generate a second image of the second beam after processing by the first band pass filter; and a third CMOS image sensor configured to generate a third image of the third beam after processing by the second band pass filter.

Example 41 is an imaging device comprising: a source of blue light configured to illuminate a sample; a long pass filter having a cutoff wavelength of 435 nm +/−5 nm; a CMOS image sensor; a first band pass filter having a critical wavelength of 520 nm +/−5 nm; a second band pass filter having a critical wavelength of 550 nm +/−5 nm; a neutral density filter; and a filter apparatus operable to selectively place the first band pass filter, the second band pass filter, or the neutral density filter between the CMOS image sensor and the long pass filter.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1-20. (canceled)

21. A method comprising:
generating one or more images of tissue inside of a patient's mouth, wherein the one or more images depict fluorescence from the tissue;
determining a pH level on the tissue using a model and pixel intensities of the one or more images; and
generating an indication of the pH level on the tissue.

22. The method of claim 21, wherein generating the one or more images comprises capturing the one or more images.

23. The method of claim 21, wherein the one or more images comprise a first image and a second image, and wherein generating the one or more images comprises:
illuminating the inside of the patient's mouth with blue light having wavelengths less than 460 nm;
capturing the first image while the inside of the patient's mouth is illuminated with the blue light, the first image representing first light that is reflected from or fluoresced from inside of the patient's mouth and subsequently filtered using a first band pass filter having a first center wavelength; and
capturing the second image while the inside of the patient's mouth is illuminated with the blue light, the second image representing second light that is reflected from or fluoresced from inside of the patient's mouth and subsequently filtered using a second band pass filter having a second center wavelength that is different from the first center wavelength,
wherein determining the pH level on the tissue comprises comparing first pixel intensities of the first image to second pixel intensities of the second image.

24. The method of claim 23, wherein the first center wavelength is within a range of 508 nm to 532 nm.

25. The method of claim 23, wherein the second center wavelength is within a range of 535 nm to 565 nm.

26. The method of claim 23, wherein using the model comprises determining a quotient of (a) a difference between one or more first intensities of one or more first pixels of the first image and one or more second intensities of one or more second pixels of the second image and (b) a sum of the one or more first intensities and the one or more second intensities.

27. The method of claim 26, wherein using the model further comprises multiplying the quotient by a first constant and then adding a second constant to obtain the pH level on the tissue.

28. The method of claim 23, further comprising:
capturing a background image of the inside of the patient's mouth while the inside of the patient's mouth is illuminated by ambient background light; and
processing the first image and/or the second image by subtracting the background image from the first image and/or the second image prior to determining the pH level on the tissue.

29. The method of claim 23, further comprising filtering the first light with a long pass filter having a critical wavelength that is less than the first center wavelength prior to filtering the first light with the first band pass filter.

30. The method of claim 23, further comprising filtering the second light with a long pass filter having a critical wavelength that is less than the second center wavelength prior to filtering the second light with the second band pass filter.

31. The method of claim 21, further comprising:
capturing a third image while the inside of the patient's mouth is illuminated with white light,
wherein generating the indication of the pH level comprises displaying a fourth image indicating the pH level on a pixel-by-pixel basis as an overlay over the third image.

32. The method of claim 31, further comprising:
capturing a background image while the inside of the patient's mouth is illuminated by ambient background light; and
processing the third image by subtracting the background image from the third image prior to determining the pH level on the tissue.

33. The method of claim 21, further comprising applying a solution comprising a sugar inside the patient's mouth, wherein generating the one or more images comprises generating the one or more images after applying the solution.

34. (canceled)

35. The method of claim 21, wherein generating the indication comprises generating the indication via a user interface.

36. The method of claim 21-34, wherein generating the indication comprises transmitting the indication via a communication interface.

37. A non-transitory computer readable medium storing instructions that, when executed by an imaging device, cause the imaging device to perform the method of claim 21.

38. An imaging device comprising:
one or more image sensors;
one or more light sources;
a user interface and/or a communication interface;
one or more processors; and
a computer readable medium storing instructions that, when executed by the one or more processors, cause the imaging device to perform the method of claim 21.

39. An imaging device comprising:
a source of blue light configured to illuminate a sample;
a source of white light configured to illuminate the sample;
a long pass filter having a cutoff wavelength of 435 nm +/−15 nm;
a beam splitter configured to receive light filtered by the long pass filter;
a first band pass filter having a critical wavelength of 520 nm +/−15 nm configured to receive a first beam from the beam splitter;
a second band pass filter having a critical wavelength of 550 nm +/−15 nm configured to receive a second beam from the beam splitter;
a first CMOS image sensor configured to generate a first image of the first beam; and
a second CMOS image sensor configured to generate a second image of the second beam.

40. An imaging device comprising:
a source of blue light configured to illuminate a sample;
a long pass filter having a cutoff wavelength of 435 nm +/−5 nm;
a first beam splitter configured to split light filtered by the long pass filter into a first beam having wavelengths less than 470 nm +/−5 nm and an axis beam having wavelengths greater than 470 nm +/−5 nm;
a first CMOS image sensor configured to generate a first image of the first beam;
a second beam splitter configured to split the axis beam into a second beam having wavelengths less than 535 nm +/−5 nm and a third beam having wavelengths greater than 535 nm +/−5 nm;
a first band pass filter having a first critical wavelength of 520 nm +/−5 nm configured to receive the second beam from the second beam splitter;
a second band pass filter having a second critical wavelength of 550 nm +/−5 nm configured to receive the third beam from the second beam splitter;
a second CMOS image sensor configured to generate a second image of the second beam after processing by the first band pass filter; and
a third CMOS image sensor configured to generate a third image of the third beam after processing by the second band pass filter.

41. (canceled)

42. The method of claim 21, wherein generating the one or more images comprises processing the one or more images.
